(19) United States
(12) Patent Application Publication
(10) Pub. No.: US 2023/0390987 A1
(43) Pub. Date: Dec. 7, 2023

(54) EXTRUSION DIE INCLUDING A MANDREL

(71) Applicant: Essentium IPCO, LLC, Pflugerville, TX (US)

(72) Inventors: Chris Rauwendaal, Auburn, CA (US); Thomas Colin Mulholland, Austin, TX (US); Ryan Joseph Vano, Pflugerville, TX (US)

(21) Appl. No.: 18/361,119

(22) Filed: Jul. 28, 2023

Related U.S. Application Data
(63) Continuation of application No. PCT/US2022/014709, filed on Feb. 1, 2022.
(60) Provisional application No. 63/144,888, filed on Feb. 2, 2021.

(51) Int. Cl. B29C 48/87; B29C 48/30; B29C 48/25

(52) U.S. Cl. CPC B29C 48/87; B29C 48/30; B29C 48/2566; B29C 48/25686

(57) ABSTRACT

An extrusion die is disclosed. The extrusion die can include a body member defining a passage therein, and the passage configured to receive heated material at an ingress end of the body member. A mandrel can be disposed within the passage and configured to divert the heated material around the mandrel within the passage as the heated material traverses the passage from the ingress end to an egress end of the body member. The mandrel can define an interior hollow portion that is configured to receive coolant.

### INTRODUCTION

The present disclosure relates to an extrusion die having internal coolant for cooling extruded products.

Extruded products having a shape with a large characteristic thickness, for example two (2) millimeters or thicker, must be cooled relatively slowly to avoid the formation of voids within the product. Voids form due to a high gradient in the temperature of the extruded product during solidification since the outside surface usually cools faster than the core of the extruded product, which can cause the extruded material to stiffen first on the outside. As a result, the molten interior material can shrink away from the core to solidify onto the outer shell.

### SUMMARY

An extrusion die is disclosed. The extrusion die can include a body member defining a passage therein, and the passage configured to receive heated material at an ingress end of the body member. A mandrel can be disposed within the passage and configured to divert the heated material around the mandrel within the passage as the heated material traverses the passage from the ingress end to an egress end of the body member. The mandrel can define an interior hollow portion that is configured to receive coolant.

In other features, the body member defines a plurality of grooves.

In other features, the plurality of grooves are defined along an exterior surface of the mandrel.

In other features, the plurality of grooves are defined along the interior surface of the hollow mandrel.

In other features, the mandrel is supported within the passage via at least a first support member and a second support member.

In other features, the first support member and the second support member define a coolant passage.

In other features, the heated material comprises a heated foodstuff material.

In other features, the heated material comprises a heated polymer material.

An extrusion die is disclosed. The extrusion die can include a body member defining a passage therein, and the passage configured to receive heated material at an ingress end of the body member. A mandrel can be disposed within the passage and configured to divert the heated material around the mandrel within the passage as the heated material traverses the passage from the ingress end to an egress end of the body member. The mandrel can define an interior hollow portion that is configured to receive coolant, and the body member defines a plurality of grooves.

In other features, the plurality of grooves are defined along an exterior surface of the mandrel.

In other features, the plurality of grooves are defined along the interior surface of the hollow mandrel.

In other features, the mandrel is supported within the passage via at least a first support member and a second support member.

In other features, the first support member and the second support member define a coolant passage.

In other features, the heated material comprises a heated foodstuff material.

In other features, the heated material comprises a heated polymer material.

An extrusion die is disclosed. The extrusion die can include a body member defining a passage therein, and the passage configured to receive heated material at an ingress end of the body member. A mandrel can be disposed within the passage and configured to divert the heated material around the mandrel within the passage as the heated material traverses the passage from the ingress end to an egress end of the body member. The mandrel can be supported within the passage via at least a first support member and a second support member The mandrel can define an interior hollow portion that is configured to receive coolant, and the body member defines a plurality of grooves.

In other features, the plurality of grooves are defined along an exterior surface of the mandrel.

In other features, the plurality of grooves are defined along the interior surface of the hollow mandrel.

In other features, the first support member and the second support member define a coolant passage.

In other features, the heated material comprises at least one of a heated foodstuff material or a heated polymer material.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a cross-section of an extrusion die including a mandrel according to an example implementation;

FIG. 2 is a cross-section of an extrusion die including a mandrel according to another example implementation;

FIG. 3 is an isometric view of an example mandrel including an internal member, e.g., a core, according to an example implementation;

FIG. 4 is an isometric view of an example internal member configured to be disposed within the mandrel according to an example implementation;

FIGS. 5 and 6 are diagrammatic illustrations of example internal members for the mandrel according to example implementations;

FIGS. 7 through 10 are diagrammatic illustrations of an example extrusion die including a mandrel according to example implementations;

FIG. 11 is a block diagram of a coolant circulation system that provides coolant fluid to the mandrel according to an example implementation.

### DETAILED DESCRIPTION

The following description is merely exemplary in nature and is not intended to limit the present disclosure, application, or uses.

Higher extrusion rates, e.g., higher line speeds, are known to sometimes produce higher melt temperature at the core of the extrudate, which limits the maximum line speed for void-free products. Reducing the temperature in the center of the product may allow higher line speeds for a given void-free product. The present disclosure is directed to an extrusion die that can lower an internal temperature of the product prior to the product being formed, which can mitigate formation of voids.

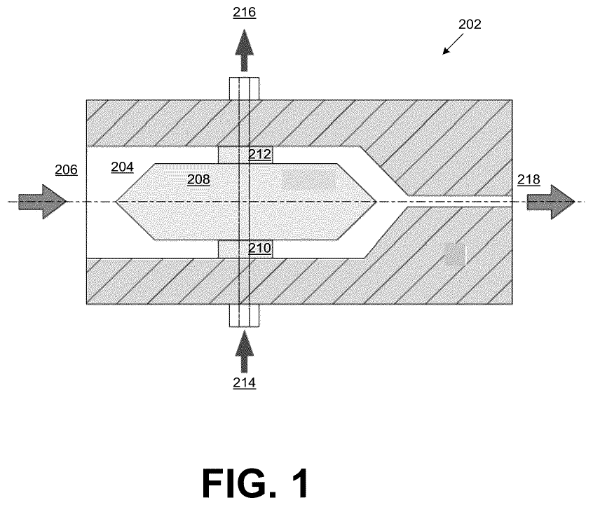

FIG. 1 illustrates a cross-section of an example extrusion die 202. As shown, the extrusion die 202, e.g., a body member, defines a passage 204 that receives a heated material, e.g., a molten material, a foodstuff material, at an ingress end 206. The extrusion die 202 includes a mandrel 208 disposed within the passage 204. The mandrel 208 can divert the heated material around the mandrel 208. It is understood that an internal configuration of the extrusion die 202 may differ with respect to the product being produced. For example, the extrusion die 202 may be configured such that an interior of the extrusion die 202 may form a sheet, a rod, a profile, or the like.

In an example implementation, the mandrel 208 is maintained within the passage 204 via at least a first support member 210 and a second support member 212. It is understood that the mandrel 208 may be maintained by additional support members in some implementations. In various implementations, the mandrel 208 may be at least partially hollow to allow for the flow of coolant flow within the mandrel 208, e.g., an interior portion of the mandrel 208 is hollow. The first support member 210 includes a coolant inlet passage 214, and the second support member 212 includes a coolant outlet passage 216. For example, the support members 210, 212 can define cavities therein that form passages. The coolant inlet passage 214 can introduce a coolant fluid into the mandrel 208, and the coolant outlet passage 216 can evacuate the coolant fluid from the mandrel 208. A coolant circulation system, which is described in greater detail below, can provide the coolant to the mandrel 208. In one or more implementations, the coolant fluid may comprise, but is not limited to: air, water, oil, or other suitable coolant fluids. The mandrel 208 may also include other supports that include a sensor for measuring the temperature of the mandrel or the heated material flowing around the mandrel. Temperature sensors may also be included with supports 210 and/or 212.

The coolant fluid can remove heat from the heated material as the heated material passes an exterior surface of the mandrel 208 due to the relatively cooler temperature of the mandrel 208 with respect to the molten filament material. The mandrel 208 can temporarily divert the heated material into a shape of a tube as the heated material travels the passage 204 from the ingress end 206 to the egress end 218. In some examples, the heated material can converge within the passage 204 proximal to the egress end 218 of the extrusion die 202.

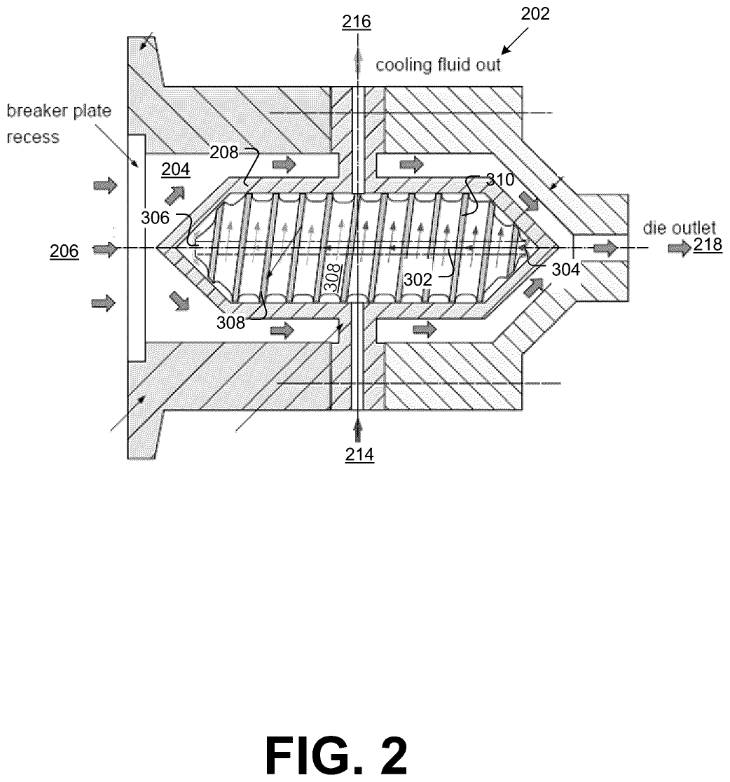

FIG. 2 illustrates a cross-section of an example implementation of the mandrel 208. In this implementation, the mandrel 208 defines an internal passage arranged in a spiral configuration, e.g., a spiral core. As shown, the coolant fluid can enter the mandrel 208 via the coolant inlet passage 214 and can be provided to a hollow channel 302. The hollow channel 302 can extend along at least partially a length of the mandrel 208, and the coolant fluid can enter the hollow channel 302 at an ingress end 304 and exits the internal tube at an egress end 306 as illustrated by the arrows. A pressure difference between the coolant inlet passage 214 and the coolant outlet passage 216 can cause the coolant fluid to travel within mandrel 208. The coolant fluid can enter into the helical channel of the spiral core and flows to the ingress end 304 in a spiraling fashion—then the coolant fluid flows through the hollow channel to the egress end 306—from there it flows through the helical channel of the spiral core toward the outlet passage 216.

Once the coolant fluid exits the internal tube at the egress end 306, the coolant fluid traverses an internal passage 308 defined by a plurality of dividers 310 disposed within an interior of the mandrel 208. The plurality of dividers 310 can be disposed such that the internal passage 308 can be arranged as a spiral to improve a temperature uniformity along a surface of the mandrel 208.

In some implementations, portions of an interior surface and/or an exterior surface of the mandrel 208 and/or an internal member 345 of the mandrel 208 may define grooves. An internal member 345 may comprise a core of the mandrel 208. In some implementations, the internal member 345 may be manufactured via a suitable machining process.

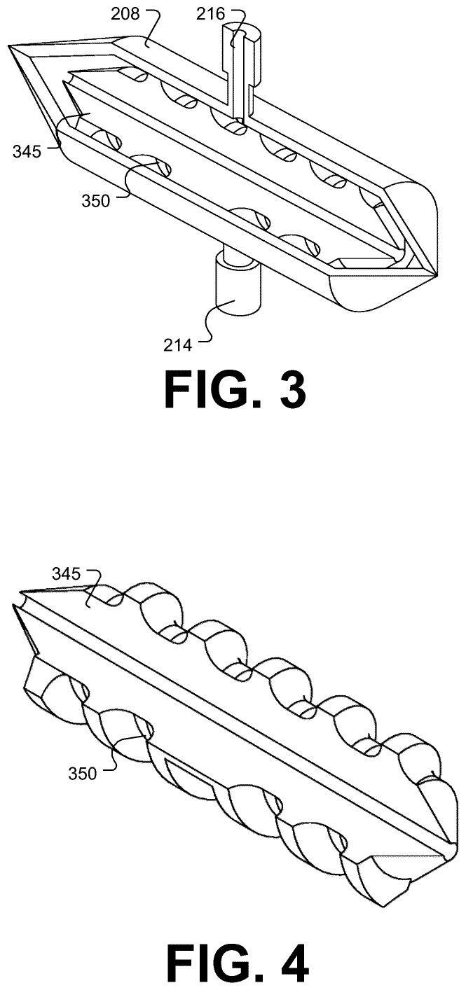

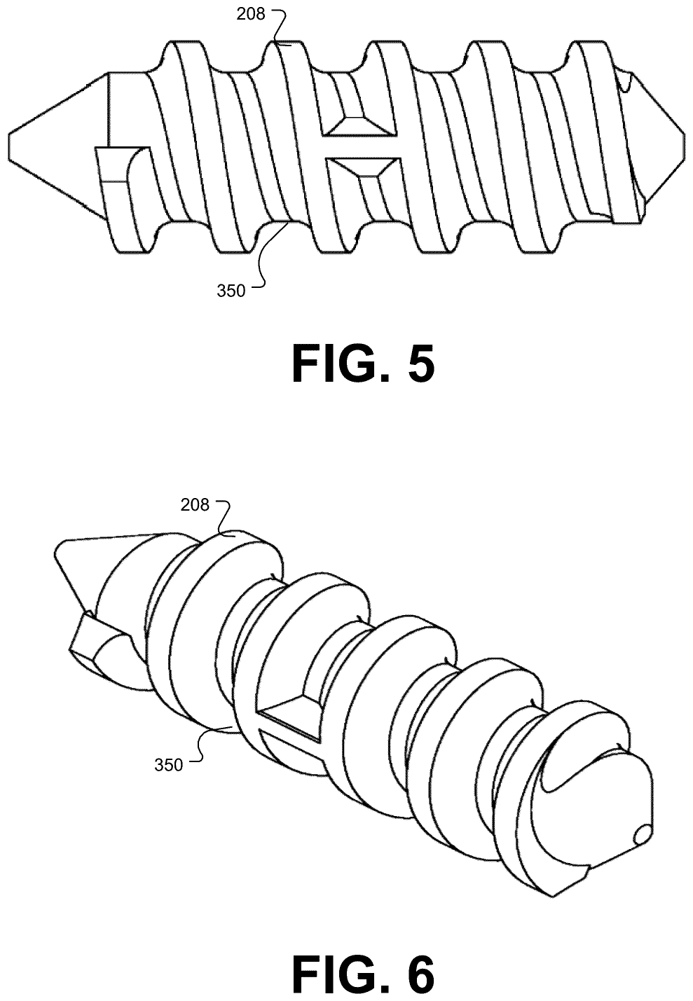

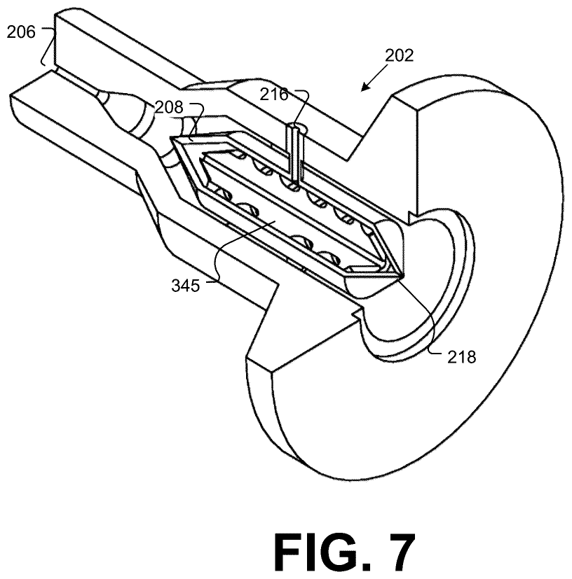

As shown in FIGS. 3 and 4, various surfaces of the internal member 345 may define grooves 350 to increase an amount of heated material and/or coolant fluid exposed to the mandrel 208 to improve heat transfer. External grooves 350 may also provide beneficial mixing to the heated material. FIGS. 5 and 6 illustrate additional example perspectives of the internal member 345 for a mandrel 208 according to various implementations. FIG. 7 illustrates an example internal member 345 disposed within a mandrel 208.

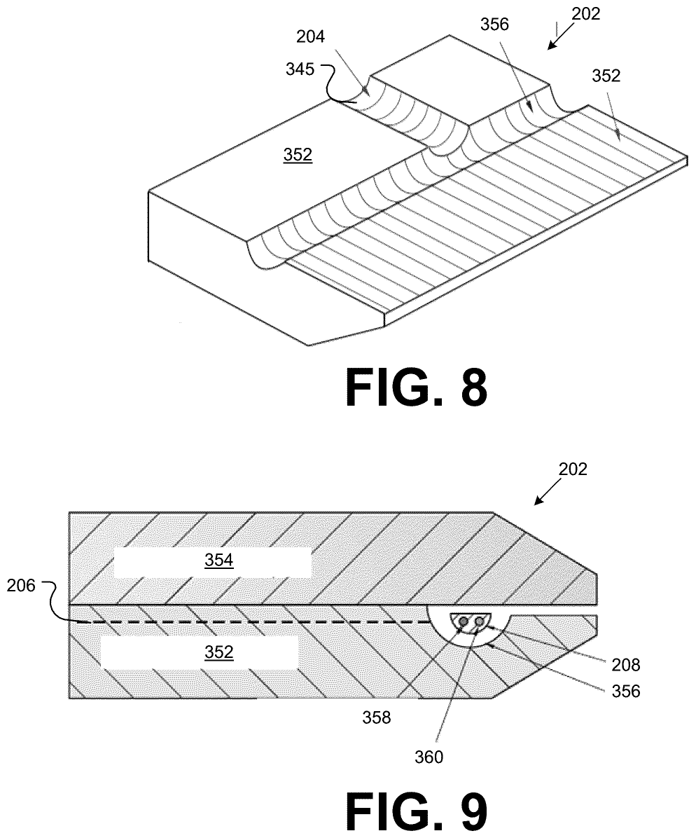

FIGS. 8 and 9 illustrate an example implementation of an example extrusion die 202 including a mandrel 208 positioned within a passage 204 that receives the heated material at an ingress end 206. The extrusion die 202 can include a first die portion 352 and a second die portion 354. As shown in FIG. 8, the first die portion 352 can define a manifold channel 356 that can receive heated material from the passage 204. In this implementation, the manifold channel 356 and the passage 204 can form a T-intersection (see FIG. 8).

FIG. 9 illustrates the mandrel 208 positioned within the manifold channel 356. In an example implementation, the mandrel 208 can define one or more channels 358, 360. The channel 358 can be configured to receive the coolant fluid, e.g., a coolant ingress, and the channel 360 can be configured to evacuate the coolant fluid from the mandrel 208, e.g., a coolant egress.

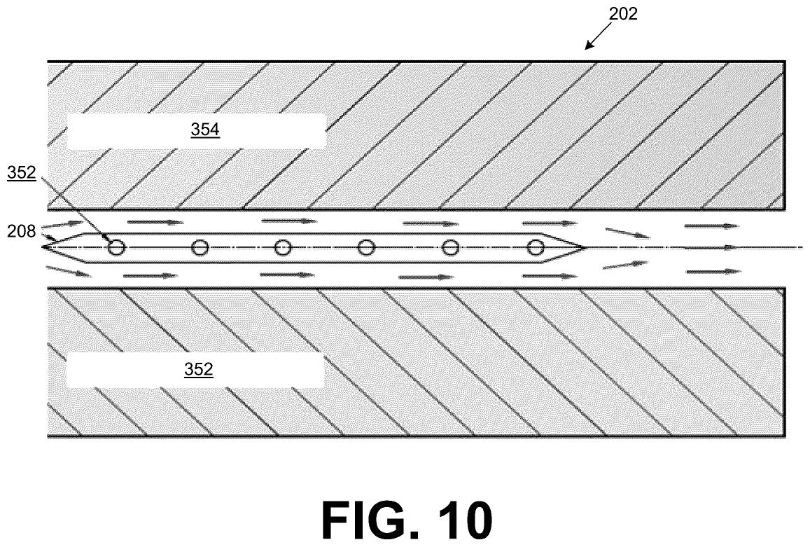

FIG. 10 illustrates another example implementation of the extrusion die 202. As shown, the die portions 352, 354 define a passage 204 with a mandrel 208 disposed within the passage 204. The mandrel 208 defines one or more channels 362 therein to receive coolant fluid.

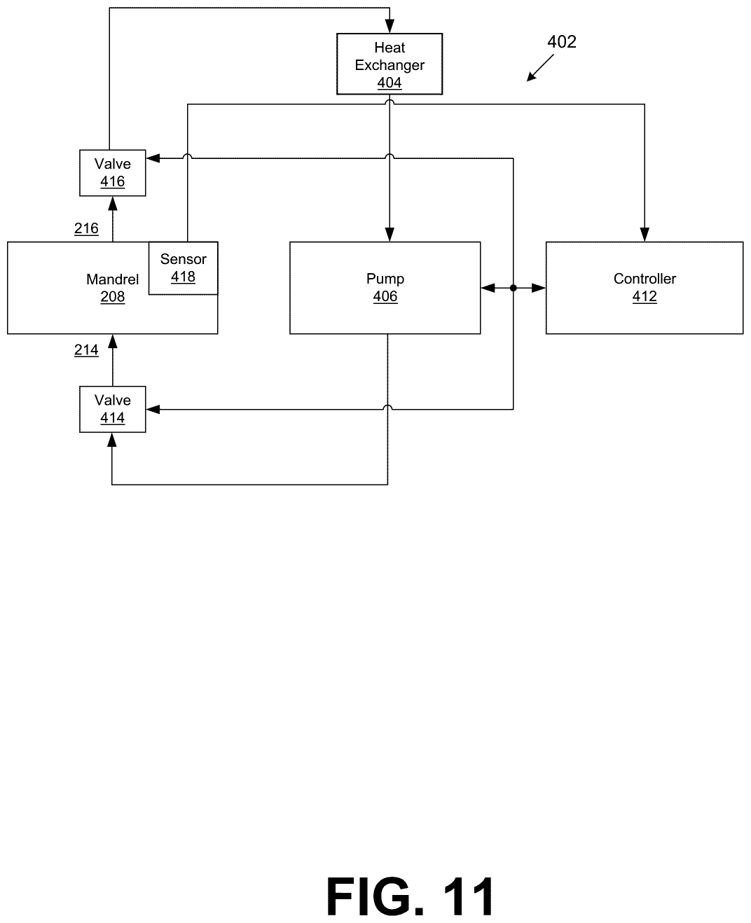

FIG. 11 illustrates an example coolant circulation system 402. The coolant circulation system 402 includes a heat exchanger 404 and a pump 406. The heat exchanger 404 extracts heat from the coolant fluid allowing the coolant fluid to absorb additional heat when circulated through the mandrel 208. As shown, the heat exchanger 404 is disposed between the pump 406 and an inlet conduit 408 that defines a passage therein. The pump 406 is disposed between the heat exchanger and an outlet conduit 410 that defines a passage therein. The pump 406 displaces the coolant fluid within the coolant circulation system 402. Additionally, the pump 406 can be used to modify the pressure differential within the mandrel 208.

The coolant circulation system 402 includes a controller 412 that is connected to the pump 406 and the valves 414, 416. The controller 412 receives temperature parameters and/or pressure parameters from one or more sensors 418. The sensor(s) 418 can be disposed within the mandrel 208 to measure a temperature within mandrel 208. In an example implementation, the sensor(s) 418 can be attached to the interior surface of the mandrel 208.

The controller 412 also receives various parameter signals from the valves 414, 416 and the pump 406. For example, the valves 414, 416 can include sensors that provide signals indicative of a flowrate at the respective valve 414, 416. The pump 406 can also include a sensor that provides signals indicative of pumping characteristics to the controller 412.

The sensor(s) 418 can measure temperatures and/or pressures within the mandrel 208 and provide the measured values to the controller 412. For example, an inlet temperature and an outlet temperature of the coolant can be measured. Based upon the measured values, the controller 412 transmits control signals to the pump 406 and/or the valves 414, 416. For example, once the measured temperature exceeds a predetermined temperature threshold, the controller 412 causes the pump 406 to pump coolant fluid into the mandrel 208 and actuates the valves 414, 416 to control a flowrate through the mandrel 208. Additionally, once the measured pressure exceeds a predetermined pressure threshold, the controller 412 actuates the valves 414, 416 to control a flowrate to regulate pressure within the mandrel 208. By regulating the pressure within the mandrel 208, the amount coolant fluid entering the mandrel 208 can be regulated.

It is understood that in some example implementations, the pump may operate continuously such that coolant fluid is continuously removed from and pushed to the mandrel 208. The pump 406 may comprise a variable speed pump such that the flow rate can be adjusted with the pump speed.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An extrusion die comprising:
a body member defining a passage therein, the passage configured to receive heated material at an ingress end of the body member; and
a mandrel disposed within the passage and configured to divert the heated material around the mandrel within the passage as the heated material traverses the passage from the ingress end to an egress end of the body member,
wherein the mandrel defines an interior hollow portion that is configured to receive coolant.

2. The extrusion die as recited in claim 1, wherein the body member defines a plurality of grooves.

3. The extrusion die as recited as claim 2, wherein the plurality of grooves are defined along an exterior surface of the mandrel.

4. The extrusion die as recited in claim 2, wherein the plurality of grooves are defined along an interior surface of the hollow mandrel.

5. The extrusion die as recited in claim 1, wherein the mandrel is supported within the passage via at least a first support member and a second support member.

6. The extrusion die as recited in claim 1, wherein the first support member and the second support member define a coolant passage.

7. The extrusion die as recited in claim 1, wherein the heated material comprises a heated foodstuff material.

8. The extrusion die as recited in claim 1, wherein the heated material comprises a heated polymer material.

9. An extrusion die comprising:
a body member defining a passage therein, the passage configured to receive heated material at an ingress end of the body member; and
a mandrel disposed within the passage and configured to divert the heated material around the mandrel within the passage as the heated material traverses the passage from the ingress end to an egress end of the body member,
wherein the mandrel defines an interior hollow portion that is configured to receive coolant,
wherein the body member defines a plurality of grooves.

10. The extrusion die as recited in claim 9, wherein the plurality of grooves are defined along an exterior surface of the mandrel.

11. The extrusion die as recited in claim 9, wherein the plurality of grooves are defined along an interior surface of the hollow mandrel.

12. The extrusion die as recited in claim 9, wherein the mandrel is supported within the passage via at least a first support member and a second support member.

13. The extrusion die as recited in claim 9, wherein the first support member and the second support member define a coolant passage.

14. The extrusion die as recited in claim 9, wherein the heated material comprises a heated foodstuff material.

15. The extrusion die as recited in claim 9, wherein the heated material comprises a heated polymer material.

16. An extrusion die comprising:
a body member defining a passage therein, the passage configured to receive heated material at an ingress end of the body member; and
a mandrel disposed within the passage and configured to divert the heated material around the mandrel within the passage as the heated material traverses the passage from the ingress end to an egress end of the body member,
wherein the mandrel is supported within the passage via at least a first support member and a second support member,
wherein the mandrel defines an interior hollow portion that is configured to receive coolant,
wherein the body member defines a plurality of grooves.

17. The extrusion die as recited in claim 16, wherein the plurality of grooves are defined along an exterior surface of the mandrel.

18. The extrusion die as recited in claim 16, wherein the plurality of grooves are defined along the interior surface of the hollow mandrel.

19. The extrusion die as recited in claim 16, wherein the first support member and the second support member define a coolant passage.

20. The extrusion die as recited in claim 9, wherein the heated material comprises at least one of a heated foodstuff material or a heated polymer material.
